(19) United States
(12) Patent Application Publication
(10) Pub. No.: US 2017/0075208 A1
(43) Pub. Date: Mar. 16, 2017

(54) INSTRUMENT CLUSTER WITH POINTER EMBEDDED WITH PROJECTOR

(71) Applicant: Raghavendra Narayan Mudagal, Gadag (IN)

(72) Inventor: Raghavendra Narayan Mudagal, Gadag (IN)

(21) Appl. No.: 15/261,298

(22) Filed: Sep. 9, 2016

(30) Foreign Application Priority Data
Sep. 10, 2015 (IN) 971/KOL/2015

(51) Int. Cl. G03B 29/00; G03B 21/00; G02B 27/02; B60K 35/00; G03B 21/14

(52) U.S. Cl. CPC G03B 29/00; B60K 35/00; G03B 21/145; G02B 27/025; G03B 21/006; B60K 2350/2052

(57) ABSTRACT

The present disclosure discloses an instrument cluster having a pointer embedded with a projector assembly. The instrument cluster includes a cluster lens for providing protective cover, projection thin film for providing display, cap assembly for holding the magnifying lens, an applique, a pointer for indicating the current measurement, projector assembly for projection of the objects on the cluster lens and PWB assembly for controlling instrument cluster operation. The pointer is shaped similar to “Z” and the projector assembly comprises space to carry the pointer.

### CROSS-REFERENCE TO RELATED APPLICATIONS

This application claims priority to Indian Patent Application No. 971/KOL/2015, filed Sep. 10, 2015 and entitled “INSTRUMENT CLUSTER WITH POINTER EMBEDDED WITH PROJECTOR,” which is herein incorporated by reference.

### BACKGROUND OF THE DISCLOSURE

The instrument cluster is an essential component in today's automotive vehicles. The instrument cluster may include a pointer, an applique, cap assembly, cluster lens, Printed Wiring Board (PWB), assembly and so on.

In conventional clusters, complex designs are adopted for pointer mechanisms. Further in most clusters, only half of the pointer is visible. A complex assembly process may be realized for the assembly of the different components of the cluster. As such, the cost of the conventional clusters becomes higher because of complex components and complex assembly processes. Furthermore, most conventional clusters are configured for two-dimensional (2D) image display.

Examples of instrument clusters shown employing conventional designs are shown in FIGS. 1, 2, 3a, and 3b. The assembly process shown in FIG. 4 is directed to an assembly process associated with conventional instrument clusters.

### SUMMARY

The primary object of the present disclosure is to provide an automotive instrument cluster gauge having pointer embedded with projector.

Another object of the present disclosure is to provide an automotive instrument cluster gauge having pointer embedded with projector, which provides real time analog and digital displays with a full pointer. A full pointer is defined as an appearance that a line associated with the indication of information is shown via the complete display screen of the instrument cluster.

Another object of the present disclosure is to provide an automotive instrument cluster gauge having pointer embedded with projector. By combining the two, a lower cost associated with the manufacture of the project/cluster may be realized.

Another object of the present disclosure is to provide an automotive instrument cluster gauge having a pointer embedded with a projector.

Another object of the present disclosure is to provide an automotive instrument cluster gauge having pointer embedded with projector, which may be capable of display information, such as a warning on the screen projected directly on the screen.

Another object of the present disclosure is to provide an automotive instrument cluster gauge having pointer embedded with projector, wherein graphics are customize-able.

In order to achieve the above mentioned objects, the present disclosure includes an instrument cluster having a pointer embedded with a projector assembly, including a cluster lens for providing protective cover, a display such as a projection thin film for providing electronic content, a cap assembly for holding the magnifying lens, an applique, a pointer for indicating the current measurement, projector assembly for projection of the objects on the cluster lens, and a PWB assembly for controlling instrument cluster operation. The pointer may be shaped similar to “Z” and the projector assembly includes space to carry the pointer.

In one embodiment, the cap assembly includes a cap and magnifying lens.

In one embodiment, a safe air gap is provided between the pointer and the projector.

In one embodiment, the applique comprises speed markings.

In one embodiment, the instrument cluster includes a LCD screen to display the digital information.

In one embodiment, the projector assembly is fixed on the PWB assembly with the help of projector holder and connected thereto with the help of a flex cable.

In one embodiment, the projector assembly comprises a pico projector assembly.

It is to be understood that both the foregoing general description and the following detailed description of the present embodiments of the disclosure are intended to provide an overview or framework for understanding the nature and character of the disclosure as it is claimed The accompanying drawings are included to provide a further understanding of the disclosure and are incorporated into and constitute a part of this specification The drawings illustrate various embodiments of the disclosure and together with the description serve to explain the principles and operation of the disclosure.

### BRIEF DESCRIPTION OF THE DRAWINGS

The above-mentioned and other features and other advantages of the disclosure will be better understood and will become more apparent by referring to the exemplary embodiments of the disclosure, as illustrated in the accompanying drawings, wherein:

FIG. 1 shows a prior art instrument cluster;

FIG. 2 shows another prior art instrument cluster;

FIGS. 3a-3b shows a prior art instrument clusters that display half of the pointer;

FIG. 4 illustrates an assembly process required for the conventional pointers,

FIG. 5 schematically illustrates an instrument cluster having virtual pointer projected on the cluster lens in accordance with one embodiment of the present disclosure,

FIG. 6 is a block diagram which schematically illustrates an automotive instrument cluster having the pointer embedded with the projector assembly in accordance with one embodiment of the present disclosure, and

FIG. 7 is a block diagram which schematically illustrates an automotive instrument cluster having the pointer embedded with the projector assembly according to another embodiment of the present disclosure.

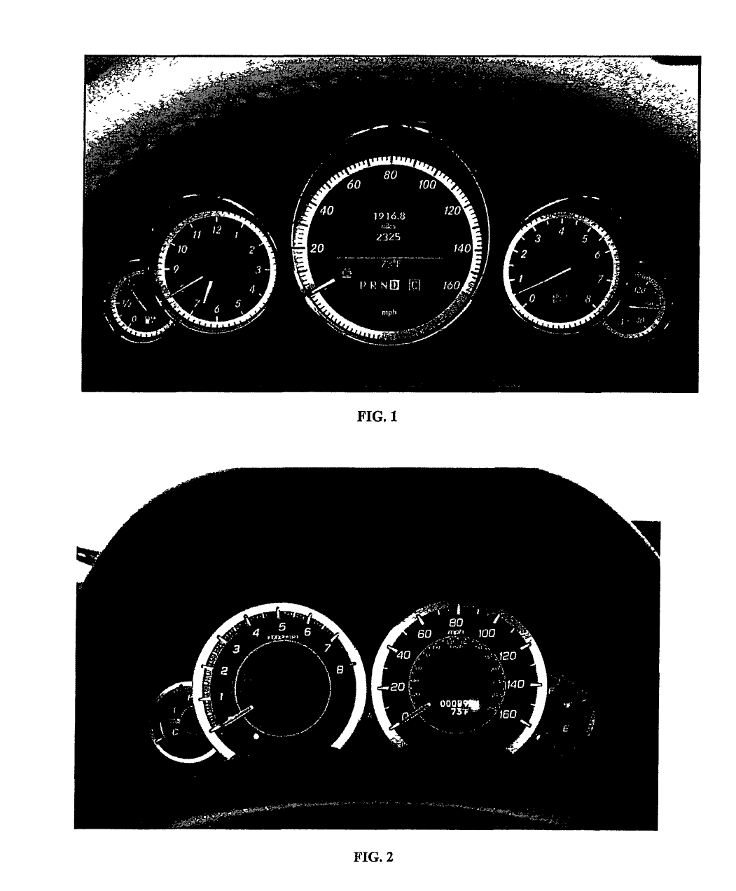

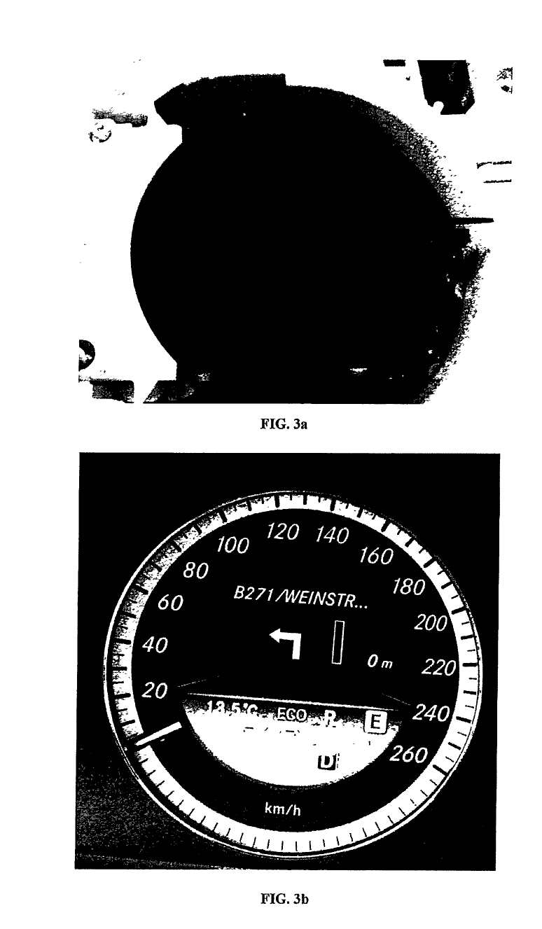

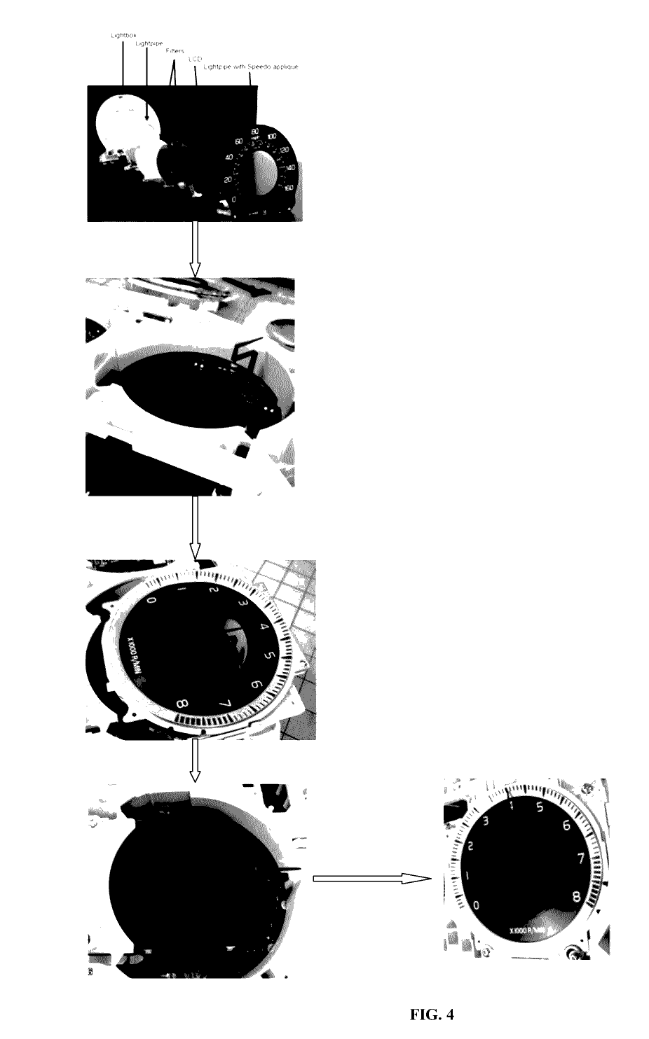

### DETAIL DESCRIPTION

Reference will now be made to the exemplary embodiments of the disclosure, as illustrated in the accompanying drawings. Wherever possible same numerals will be used to refer to the same or like parts.

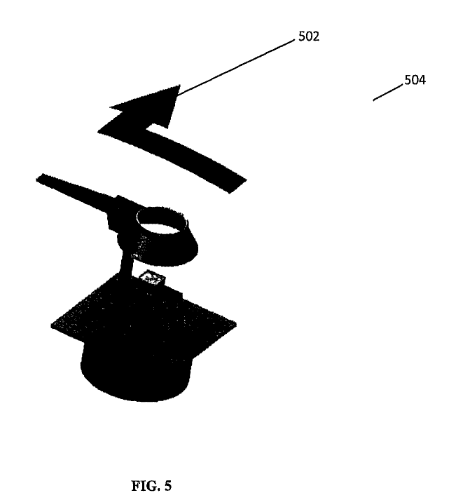

Disclosed herein is an automotive instrument cluster having pointer embedded with the projector assembly In the present disclosure, the pointer has embedded with projector on moving subsystem and information is produced on the lens of cluster FIG. 5 schematically illustrates such an instrument cluster having virtual pointer (502) projected on the cluster lens (504) in accordance with one embodiment of the present disclosure. The embodiment in FIG. 5 will be shown in greater detail below.

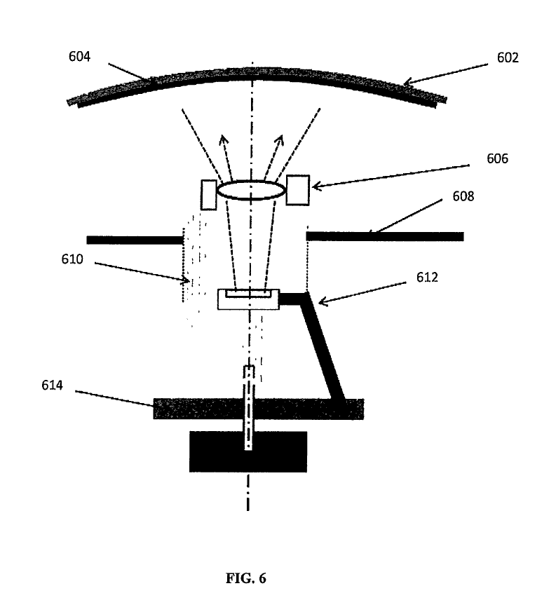

FIG. 6 is a block diagram which schematically illustrates an automotive instrument cluster having the pointer embedded with the projector assembly in accordance with one embodiment of the present disclosure.

The instrument cluster includes a cluster lens (602), a projector thin film (604), a cap assembly (606), an applique (608), pointer blade (610), projector assembly (612), and a PWB assembly (not shown). The cap assembly (606) further may include cap and magnifying lens.

Also shown in FIG. 6 is a pointer having shape similar to “Z”. The “Z” pointer (610) includes space to include a pico projector (612). A safe air gap is provided between the pointer (610) and the projector (612). The cap includes projector lens embedded within the cap assembly (606).

The pico projector assembly (612) is fixed on the PWB (614) by employing a mechanical fastening device such as a projector holder, and connected with a flex cable to the PWB board.

Like the instrument clusters described in the prior art, the pointer is configured to rotate around an axis. However, as explained in FIG. 6, the pointer 610 is embedded with a projector 612. The pointer 610 is configured to project via the cap assembly 606 information such as direction, speed in numeric, or any other warning like left turn, oil check and other tell tails. The pointer 610 is embedded with the projector 612, while still being rotate-able via an axis.

Thus, through center of the pointer 610, information and content is projected onto the lens screen providing a secondary indication of information from the same assembly, while being integrated with a conventional pointer design.

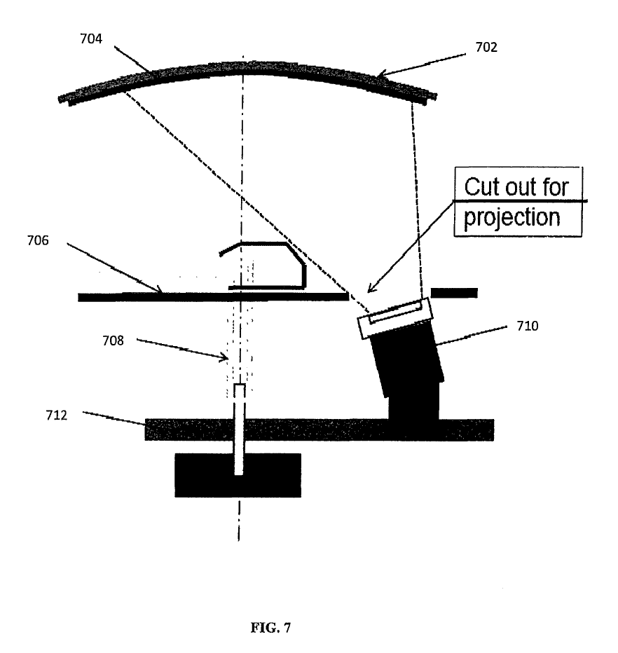

FIG. 7 is a block diagram which schematically illustrates an automotive instrument cluster having the pointer embedded with the projector assembly according to another embodiment of the present disclosure. The instrument cluster includes a cluster lens (702), a projection thin film (704), an applique (706), a pointer assembly (708), a projector assembly (710), a PWB assembly, and so on. The alternative configuration includes rotating a digital image through re-rendering the digital image, thereby keeping the projector assembly (710) static-mounted. In yet another embodiment, a pointer image may be provided using the projector in place of a mechanical pointer. In an analog and digital combined cluster several alternative configurations may be provided such as:

non-rotating graphic with mechanical pointer (information like navigation or tell-tale graphic reference proposal 1 and 2);
Rotating pointer (only projected image of rotating pointer no other information and no mechanical pointer); and
combined images (pointer and applique graphic).

The present disclosure does not include any complex mechanism only the existing pointer technology is used with bit modification. The present disclosure is simple in construction and is cost effective. Another advantage of the present disclosure is that full pointer is visible with cap assembly.

It is to be understood by a person of ordinary skill in the art that various modifications and variations may be made without departing from the scope and spirit of the present disclosure. Therefore, it is intended that the present disclosure covers such modifications and variations provided they come within the ambit of the appended claims and their equivalents.

What is claimed is:

1. An instrument cluster having a pointer embedded with a projector assembly, comprising
a cluster lens for providing protective cover, a
projection thin film for providing display, a cap
assembly with a magnifying lens,
an applique,
a pointer rotate-able around an axis, the pointer being included with the cap assembly in a central portion of rotation,
a projector assembly configured to project digital content via the magnifying lens of the cap assembly, and
wherein the projector assembly is embedded in the pointer.

2. The instrument cluster as claimed in claim 1, wherein the cap assembly comprises a cap to hold the magnifying lens.

3. The instrument cluster as claimed in claim 1, wherein an air gap is provided between the pointer and the projector assembly.

4. The instrument cluster as claimed in claim 1, wherein the applique comprises a speed marking.

5. The instrument cluster as claimed in claim 1, comprising a LCD screen to display the digital information.

6. The instrument cluster as claimed in claim 1, wherein the projector assembly is fixed on a PWB assembly with a projector holder, and connected to the PWB assembly via a flex cable.

7. The instrument cluster as claimed in claim 1, wherein the projector assembly is a pico projector assembly.

8. The instrument cluster as claimed in claim 1, wherein the digital content is re-rendered based on rotation by the pointer.
